(19) United States
(12) Patent Application Publication
(10) Pub. No.: US 2003/0189595 A1
(43) Pub. Date: Oct. 9, 2003

(54) Summary data visualisation system and method

(76) Inventor: Thomas Richard Beard, Wellington (NZ)

Correspondence Address: David E. Bruhn, DORSEY & WHITNEY LLP, Intellectual Property Department, 50 South Sixth Street, Suite 1500, Minneapolis, MN, 55402-1498, US

(21) Appl. No.: 10/364,659

(22) Filed: Feb. 11, 2003

Related U.S. Application Data
(63) Continuation of application No. PCT/NZ01/00163, filed on Aug. 10, 2001.

(30) Foreign Application Priority Data
Aug. 11, 2002 (NZ) 506304

(51) Int. Cl. G09G 5/00

(52) U.S. Cl. 345/764

(57) ABSTRACT

The invention provides a data visulisation system comprising a data value memory in which is maintained an interaction database of interaction data representing interactions between customers and merchants, the interaction data associated with at least one time value, a retrieval device arranged to retrieve from the interaction database data representing interactions between customers and merchants and to construct a finite set of data values from their retrieved data, a display arranged to display a first representation of the data values, and a pointing device enabling a user to select part of the first representation. The display is further arranged to generate and display a second representation based on the part of the first representation selected by the user.

### CROSS REFERENCE TO RELATED APPLICATIONS

This application is a continuation of International Patent Application No. PCT/NZ01/00163, filed on Aug. 10, 2001, which claims priority to an earlier filed New Zealand Patent Application No. 506304, filed on Aug. 11, 2000, both of which are incorporated herein by reference.

### FIELD OF INVENTION

The invention relates to a summary data visualisation system and method, particularly but not solely designed for use in presenting interactive drill down representations.

### BACKGROUND TO INVENTION

The low cost of data storage hardware has led to the collection of large volumes of data. Merchants, for example, generate and collect large volumes of data during the course of their business. To compete effectively, it is necessary for a merchant to be able to identify and use information hidden in the collected data. This data could include shop floor sales, and where the merchant operates a website, the use that is made of the website may also be collected. The task of identifying this hidden information has proved very difficult for merchants.

Traditionally, analysis of data has been achieved by running a query on a set of data records stored in a database. The merchant or other party first creates a hypothesis, converts this hypothesis to a query, runs the query on the database, and interprets the results obtained with respect to the original hypothesis.

One disadvantage of this verification-driven hypothesis approach is that the merchant must form a desired hypothesis in advance. This is merely confirming what the merchant already suspects and does not provide the merchant with information which may be unexpected. Another disadvantage is that the merchant needs to have available the technical knowledge to formulate the appropriate queries.

### SUMMARY OF INVENTION

In broad terms in one form the invention comprises a data visualisation system comprising an interaction database of interaction data maintained in computer memory representing interactions between customers and merchants, the interaction data associated with at least one time value; a retrieval device configured to retrieve from the interaction database data representing interactions between customers and merchants and to construct a finite set of data values from the retrieved data; a display configured to display a grid of individual cells representing the data values, each cell representing a day and time interval; and a pointing device enabling a user to select a cell in the grid; the display further configured to generate and display at least one histogram based on the cell selected by the user, the histogram positioned in close proximity to the grid of individual cells.

In broad terms in another form the invention comprises maintaining in an interaction database interaction data representing interactions between customers and merchants, the interaction data associated with at least one time value; retrieving from the interaction database data representing interactions between customers and merchants; constructing a finite set of data values from the retrieved data; displaying a grid of individual cells representing the data values, each cell representing a day and time interval; providing a pointing device enabling a user to select a cell in the grid; and generating and displaying at least one histogram based on the cell selected by the user, the histogram positioned in close proximity to the grid of individual cells.

### BRIEF DESCRIPTION OF THE FIGURES

Preferred forms of the summary data visualisation system and method will now be described with reference to the accompanying figures in which:

FIG. 1 shows a block diagram of a system in which one form of the invention may be implemented;

FIG. 2 shows the preferred system architecture of hardware on which the present invention may be implemented;

FIG. 3 shows a block diagram of a system in which another form of the invention may be implemented;

FIG. 4 is a preferred representation generated in accordance with the invention; and

FIG. 5 is a flow chart of a preferred form of the invention.

### DETAILED DESCRIPTION OF PREFERRED FORMS

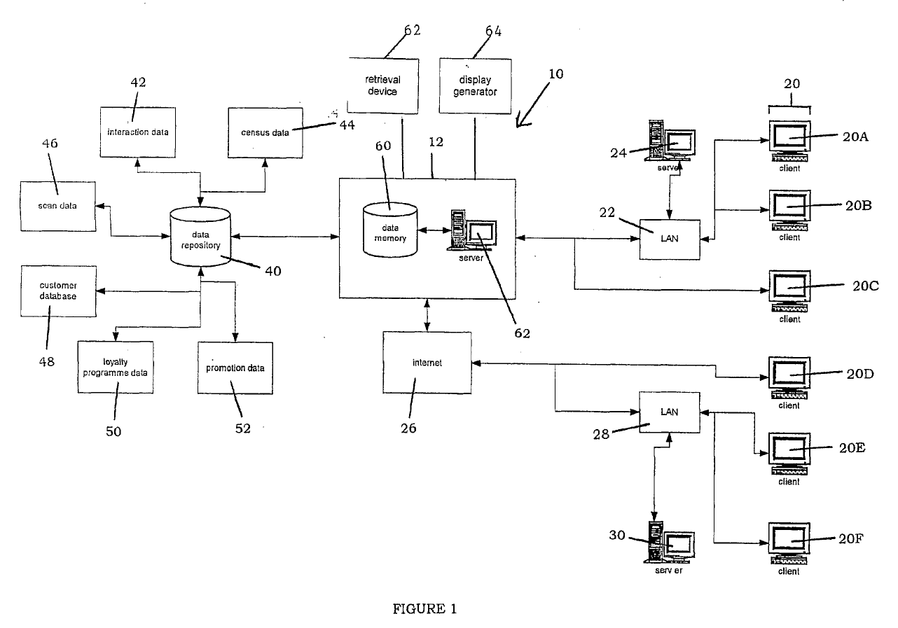

FIG. 1 illustrates a block diagram of the preferred system 10 in which one form of the present invention may be implemented. The system includes one or more clients 20, for example 20A, 20B, 20C, 20E and 20F, which each may comprise a personal computer or workstation described below. Each client 20 is interfaced to a workstation 12 as shown in FIG. 1. Each client 20 could be connected directly to the workstation 12, could be connected through a local area network or LAN, or could be connected through the Internet.

Clients 20A and 20B, for example, are connected to a network 22, such as a local area network or LAN. The network 22 could be connected to a suitable network server 24 and communicate with the workstation as shown. Client 20C is shown connected directly to the workstation using for example a serial connection or WAP connection. Clients 20D, 20E and 20F are shown connected to the workstation through the Internet 26. Client 20D is shown as connected to the Internet 26 with a dial-up connection and clients 20E and 20F are shown connected to a network 28 such as a local area network or LAN, with the network 28 connected to a suitable network server 30.

The preferred system 10 further comprises a data repository 40, for example a data warehouse maintained in a memory. It is envisaged that the data repository may alternatively comprise a single database, a collection of databases, or a data mart. The preferred data repository 40 includes data from a variety of sources. The data repository may include, for example, interaction data 42 representing interactions between customers and merchants as will be more particularly described below. The data repository may also include data from other sources for example census data 44, scan data 46 obtained from scanning bar-codes on products, data from merchant customer databases 48, data from merchant loyalty programmes 50 and/or promotion data 52 held by a merchant or other organisation.

The personal computer or workstation preferably operates under the control of appropriate operating and application software, and has a data memory 60 connected to a server 62. The invention includes a retrieval device or retrieval component 62 which in one form comprises a software implemented query enabling retrieval of data from the data repository 40, and in another form comprises a memory on which the query is installed and operating. The data retrieved using the retrieval device 62 is processed with the server 62. A display generator 64 which in one form comprises a computer implemented software program generates a display of the data on a client workstation 20, as will be described below. A display component (not shown) could comprise a conventional display software module interfaced to the display generator 64 and operable to display data on a client 20. Preferred forms of the display generator computer program are also described below.

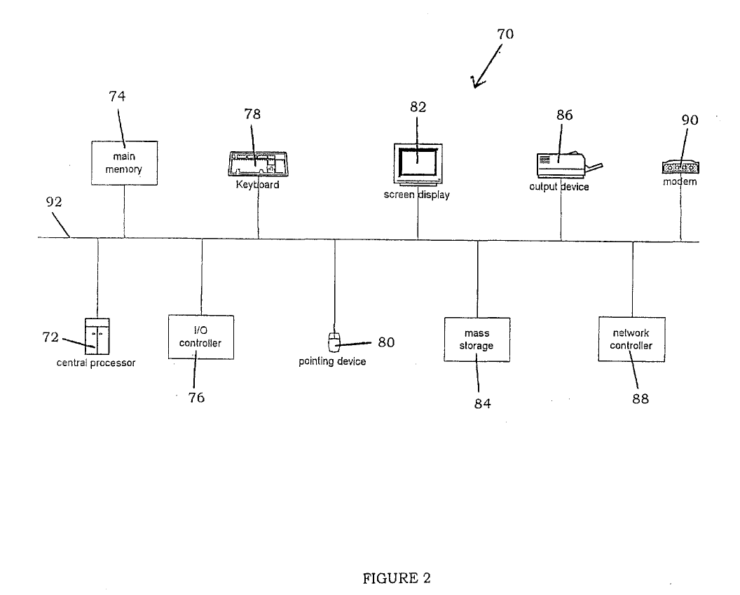

FIG. 2 shows the preferred system architecture of a client 20 or workstation 12. The computer system 70 typically comprises a central processor 72, a main memory 74 for example RAM and an input/output controller 76. The computer system 70 also comprises peripherals such as a keyboard 78, a pointing device 80 for example a mouse, track ball, touch pad, or cursor key set, a display or screen device 82, a mass storage memory 84 for example a hard disk, floppy disk or optical disc, and an output device 86 for example a printer. The system 70 could also include a network interface card or controller 88 and/or a modem 90. The individual components of the system 70 could communicate through a system bus 92.

It is envisaged that the invention have a wide area of application and the nature and format of the data stored in the data repository 40 will be different for each application. Different applications of the invention are set out below. In each case, the invention 12 is arranged to display a contoured representation of data on a screen display of a client workstation 20.

In one form, the invention is arranged to display data representing interactions between customers and merchants. Typically, a merchant will operate in a commercial premises or store from which a customer purchases goods or services. The merchant may, for example, operate a petrol station in one or more geographic locations. The merchant may alternatively operate a wagering or betting service, or operate a casino or other gaming facility in which a plurality of gaming machines and stations are positioned in one or more rooms at a common venue. The merchant may also operate a warehouse facility, manufacturing facility, carparking premises, telecommunications network or website. The merchant may also offer a range of financial or insurance services.

The merchant does not necessarily need to operate from a commercial premises or store. For example, the merchant may operate from strategically placed machines, for example vending machines or amusement machines. The merchant may also operate a mail order catalogue service, direct market goods or services, or operate from a website or other electronic medium. It will be appreciated that the nature of business of a merchant includes a wide range of activities.

As a customer interacts with a merchant, the interaction generates interaction data which is then migrated to the data repository 40. The interaction data could be stored as a series of records in a relational database. Each record may include a merchant identifier used to identify a particular merchant, and where a merchant operates from more than one geographic location, the merchant identifier or some other identifier included in the record may identify the geographic location in which the interaction occurs.

The record could also include a customer identifier. The merchant may, for example, issue an incentive-supported customer loyalty card which is then used by the customer during interactions with the merchant. The loyalty card preferably has stored on it a customer identifier and may have stored other data, for example residential address and family size of the customer. Such data is stored in loyalty programme database 50 and could be migrated to the data repository 40.

The record could also include data such as the date and/or time at which the interaction between the customer and the merchant took place. The date and/or time value is an example of a time value with which each interaction is associated. It is envisaged that the interaction record could include the time an interaction commenced and the time an interaction ended. The duration of each duration could then be calculated from the difference in the two time values to enable statistics to be displayed, as will be described below. The duration of the interaction could be stored in the interaction data set for ease of access, or could simply be calculated when needed. The time values could include for example the day of the week and/or the hour time interval of the interaction. It is also envisaged that the record could include the cash value of the transaction.

Where the merchant operates retail premises, the merchant may have installed apparatus for reading the bar-codes of products sold. Alternatively, each product may be identified by a code assigned by the merchant which is recorded at the time of sale. Such data is stored in a scan database 46 and could be migrated to the data repository 40. In this way, the record may also include a suitable goods or services identifier, for example a product or service code to identify which goods or services were involved in the interaction.

The interaction data is migrated to the data repository 40, generally by way of daily updates or in real time. It is advantageous to cleanse, catalogue and validate the interaction data during migration of the data to the data repository and this task could be performed by either the merchant or by a third party. Once stored in the data repository 40, the data could be linked to other sources of data for subsequent retrieval, for example the census data 44, scan data 46, data from the merchant customer database 48, data from a merchant loyalty programme 50 and/or promotion data 52 held by the merchant.

The data repository 40 could be maintained by a merchant or alternatively could be maintained by a third party. Updates to the data repository could be carried out by the merchant directly, or alternatively the merchant could provide batched data to a third party for updating the data. Alternatively, a third party could be entrusted with the task of collecting the interaction data and migrating the data to the data repository.

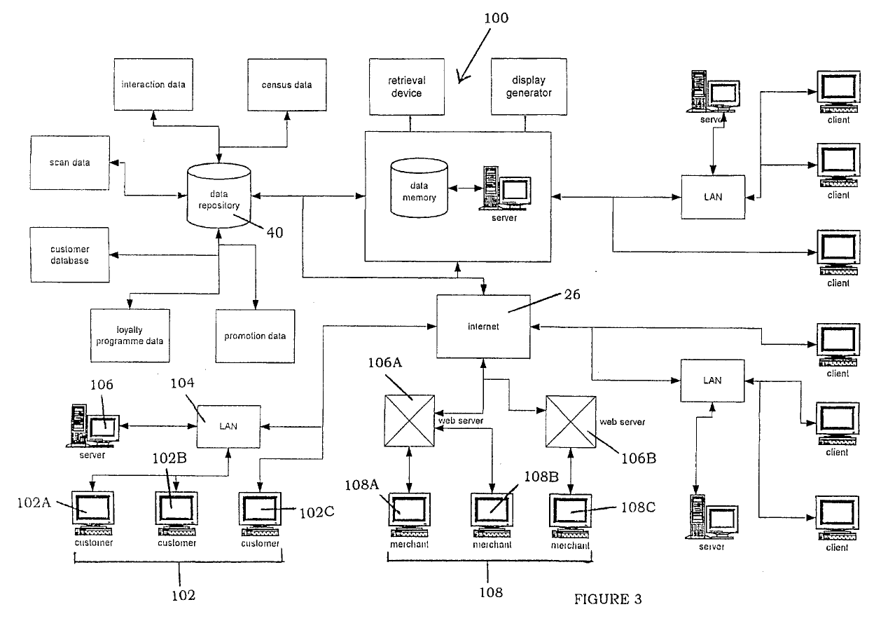

It is becoming increasingly common for merchants to operate websites as part of their business. FIG. 3 illustrates a block diagram of the preferred Internet-based system 100 in which the present invention may be implemented. The system is similar to that of FIG. 1 with the exception that the data repository 40 could be connected to the Internet 26. The system further comprises customer and merchant workstations. There could be one or more customers 102 for example customers 102A, 102B and 102C, which may each operate a personal computer or workstation as described above. Each customer 102 is interfaced to the Internet 26. As shown in FIG. 3, each customer 102 could be connected directly to the Internet as shown with 102C with a suitable dial-up connection or could be connected through a local area network or LAN as is the case with customers 102A and 102B which are connected to local area network or LAN 104, connected to a network server 106, and communicate with the Internet 26 as shown.

The system also includes one or more web servers 106, for example 106A and 106B. Each web server 106 is connected to the Internet 26 as shown. Each web server 106 preferably comprises a personal computer or workstation operating under the control of suitable software. Connected to web server 106 are one or more merchant computers or workstations 108, for example 108A, 108B and 108C. Two or more merchants could be connected to the same web server as is the case with merchant 108A and 108B both connected to web server 106A. Alternatively, merchant 108C, for example, could be connected to dedicated web server 106B.

The merchant 108 could include an individual, a company or organisation and would typically operate a website or other electronic medium through which customer 102 purchases goods or services. The merchant may alternatively operate an on-line casino, gambling or other gaming facility. The merchant could also offer transport and delivery, financial or banking services.

Customer 102 could include an individual, a company, or an organisation. The customer could be a purchaser of goods or services from the merchant or could simply be visiting a website operated by the merchant. An interaction between a customer 102 and a merchant 108 could be initiated by either the customer or by the merchant. As the customer 102 interacts with merchant 108, the interaction generates interaction data which is collected and stored in data repository 40.

Typical data records could include, for example, a merchant identifier. This merchant identifier could be used to identify a particular merchant and could comprise the universal resource locator (URL) of a website operated by the merchant, or an Internet protocol (IP) address for the merchant.

The record could include a customer identifier. The customer identifier could include the IP address or other network address of the customer 102. The customer identifier could alternatively comprise a character string assigned to the customer by the merchant during a registration process with a facility for the customer to supply a user name and password, to initiate an interaction in the known way.

The record could also include the universal resource locator (URL) of a web page visited by the customer 102 during an interaction. The record could include other information such as the date and/or time at which the interaction between the customer and the merchant took place, the cash value of any transaction if applicable, and a goods/services identifier where a transaction has taken place. It is envisaged that each new URL visited by a customer, for example each new page visited in a merchant website, generates a new interaction record. By retrieving and storing these records by date and time, it is possible to calculate the number of customers visiting a particular website and the average time spent viewing a particular web page or page cluster, as will be more particularly described below.

The system may present data to the user based on one of a number of key performance indicators or KPIs which could include total sales, gross profit, net profit, gross margin return on inventory investment (GMROII), net margin return on inventory investment (NMROII), return on net asset (RONA), loyalty sales data, time spent viewing a particular website and/or a web page visitation percentage. Each representation could show, for example, a combination of a number of customers, the number of sales and gross profit.

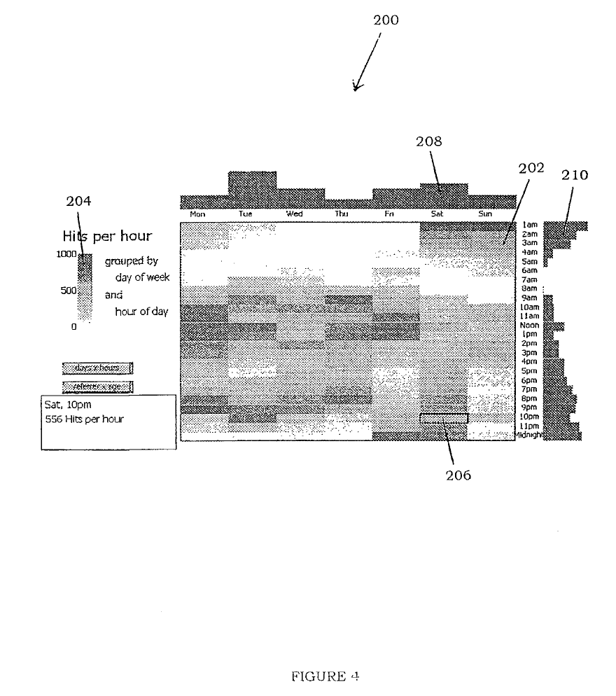

FIG. 4 illustrates at 200 one example of a display generated by the system where the merchant operates a website or other facility. The representation 200 in turn comprises a first representation 202 of data values. The representation 202 is preferably arranged in a grid of individual cells, each cell representing website usage data values during a pre-specified time interval. Representation 202 could show, for example, website usage of a particular website over a week, grouped in one hour blocks.

Each cell or block is preferably colour-coded to represent the number of hits the site has received and it is envisaged that a suitable legend 204 relating colours to actual numbers could be displayed adjacent the representation 202.

The system may further comprise a cursor 206, the position of which may be manipulated by a user with a suitable pointing device 80 from FIG. 2. As shown in FIG. 4, the user has selected the cell representing a one hour time period commencing at 10.00pm on Saturday.

The system could further comprise a second representation 208 or 210 or combination of representations 208 and 210. Representation 208 could comprise a histogram or bar graph showing the number of website hits for the one hour time period commencing at 10.00pm for each of the days Monday through Sunday. As the user selects a different cell of interest, the histogram 208 is preferably updated to correspond with the cell selected by the user. For example, should the user select Thursday 9.00am, the histogram 208 could preferably be updated and displayed, showing the number of website hits from Monday through Sunday at 9.00am.

In one preferred form, the system is configured to generate and display the representation 208 automatically based on the part or cell of the representation 202 selected by the user. Preferably the user will simply move the cursor using a pointing device to a different position without requiring separate mouse clicks or other action.

The representation 200 could further comprise one or more further representations for example histogram 210 showing all of the hits for a particular day. As shown in FIG. 4, the user has selected the cell representing Saturday at 10.00pm with cursor 206. The histogram 210 shows the website hits for each hour on Saturday.

The individual values represented by each cell represents a finite set of data values. Each cell is displayed at a set of co-ordinates relative to the time value or time values associated with each data value. For example, the cell representing a time period on Monday commencing at 3am is positioned to the left of the same time period commenced on Wednesday. The cell representing the time interval on Wednesday commencing at 9am is displayed below the above mentioned time period commencing at 3am on Wednesday.

Each of representations 208 and 210 are displayed at sets of co-ordinates relative to the time value or time values associated with the individual cell values. For example, the number of hits on a Saturday is presented in histogram 208 at substantially the same x co-ordinates as the cells representing website hits on Saturday. Similarly, data values for hits at 4pm in representation 210 are displayed substantially at the same y co-ordinates as the cell values of the time period commencing at 4pm for the days Monday through to Sunday.

In this way, the user can be provided with a summary of operational parameters of some aspect of an application or business operation. The system may summarise several dimensions simultaneously, and present the summarised data visually.

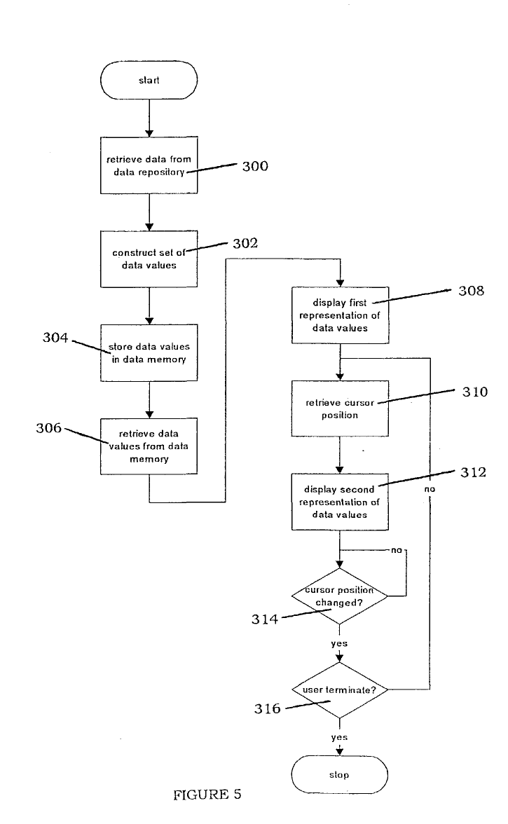

FIG. 5 illustrates the preferred method of operation of the invention. As shown at 300, data is retrieved from the data repository 40 using a suitable query. The retrieved data could include data representing interactions between customers and merchants, where this data is stored in the data repository 40.

As shown at 302, a set of data values is constructed from the retrieved data. This set of data values could include, for example, the number of hits experienced at a particular website over a pre-defined period.

It is envisaged that the set of data values could be stored in data value memory 60 to increase efficiency of the system as indicated at 304, which could comprise volatile main RAM or non-volatile mass storage of the workstation on which the invention is implemented.

Referring to step 306, the set of data values are retrieved from the volatile or non-volatile data memory and as shown at 308, a first representation is generated and displayed on a client workstation 20.

As indicated at 310, the cursor position is retrieved and as shown at 312, a second representation of data values is generated and displayed based on the cursor position retrieved at step 310.

If the user changes cursor position as indicated at 314 and the user does not wish to terminate the display as indicated at 314 and the user does not terminate the display as indicated at 316, the cursor current position is retrieved at step 310 and the second representation updated based on the new cursor position.

It will be appreciated that the uses and potential areas of application of the system are wide and varied. Merchants and other organisations do not need to follow the traditional approach of forming a hypothesis in advance and then verifying the hypothesis, although the representations generated by the system may be useful for verifying a particular hypothesis. The system presents data in an easily interpreted and intuitive manner which may be useful in identifying unexpected trends in the data.

The foregoing describes the invention including preferred forms thereof. Alterations and modifications as will be obvious to those skilled in the art are intended to be incorporated within the scope hereof, as defined by the accompanying claims.

1. A data visualisation system comprising:
an interaction database of interaction data maintained in computer memory representing interactions between customers and merchants, the interaction data associated with at least one time value;
a retrieval device configured to retrieve from the interaction database data representing interactions between customers and merchants and to construct a finite set of data values from the retrieved data;
a display configured to display a grid of individual cells representing the data values, each cell representing a day and time interval; and
a pointing device enabling a user to select a cell in the grid;
the display further configured to generate and display at least one histogram based on the cell selected by the user, the histogram positioned in close proximity to the grid of individual cells.

2. A data visualisation system as claimed in claim 1 wherein the grid comprises a series of data value representations, each data value representation displayed at a set of co-ordinates relative to the time value(s) associated with each data value.

3. A data visualisation system as claimed in claim 1 wherein the histogram comprises a series of data value representations, each data value representation displayed at a set of co-ordinates relative to the time value(s) associated with the data values of the grid.

4. A data visualisation system as claimed in claim 1 wherein the histogram represents the same time interval as the user selected cell and a series of day intervals.

5. A data visualisation system as claimed in claim 1 wherein the histogram represents the same day interval as the user selected cell and a series of time intervals.

6. A method of data visualisation comprising the steps of:
maintaining in an interaction database interaction data representing interactions between customers and merchants, the interaction data associated with at least one time value;
retrieving from the interaction database data representing interactions between customers and merchants;
constructing a finite set of data values from the retrieved data;
displaying a grid of individual cells representing the data values, each cell representing a day and time interval;
providing a pointing device enabling a user to select a cell in the grid; and
generating and displaying at least one histogram based on the cell selected by the user, the histogram positioned in close proximity to the grid of individual cells.

7. A method of data visualisation as claimed in claim 6 wherein the step of displaying the grid further comprises the steps of displaying a series of data value representations at a set of co-ordinates relative to the time value(s) associated with each data value.

8. A method of data visualisation as claimed in claim 6 wherein the step of displaying the histogram further comprises the steps of displaying a series of data value representations at a set of co-ordinates relative to the time value(s) associated with the data values of the grid.

9. A method of data visualisation as claimed in claim 6 wherein the histogram represents the same time interval as the user selected cell and a series of day intervals.

10. A method of data visualisation as claimed in claim 6 wherein the histogram represents the same day interval as the user selected cell and a series of time intervals.
